(19) United States
(12) Patent Application Publication
(10) Pub. No.: US 2010/0103439 A1
(43) Pub. Date: Apr. 29, 2010

(54) SYSTEM AND METHOD FOR VISUAL CONFIGUATION OF DYNAMIC DOCUMENT HOLE PLACEMENT

(75) Inventors: Stuart Curtis Zak, Rochester, NY (US); John Glenn Powers, Ontario, NY (US); Jaden Michael James Bruun, Rochester, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/258,706

(22) Filed: Oct. 27, 2008

(51) Int. Cl. H04N 1/60

(52) U.S. Cl. 358/1.9; 358/1.15

(57) ABSTRACT

Document processing systems and methods are presented in which a hole select system is connected to a graphical user interface that visually renders a media image representative of a printed media, the interface includes at least one hole indicia on the media image, and allows the hole indicia to be manipulated by the user and the hole select system generates and provides hole location data to a hole creation system to produce holes on the printed media.

### BACKGROUND

The present exemplary embodiment relates to document processing systems such as printers, copiers, multi-function scanner/printer/copier/fax devices, etc., and more particularly to document processing systems having integrated hole punching, drilling, and/or cutting capabilities. Modern document processing machines provide a variety of features and functions available to a user in printing and finishing document print jobs. Many of these systems include automatic hole creation devices that selectively create holes in the printed document pages.

### BRIEF DESCRIPTION

One or more aspects of the present disclosure provide a document processing system with a print engine and a finishing station that receives printed media from the print engine. The finishing station includes a hole creation system that is creates holes in the printed media based on hole location data. The system further includes an interface allowing the user to visually specify document hole locations without the need to enter numeric values. The interface has a display to visually render at least a portion of a media image representing the printed media. Additionally, the document process system includes a hole select system connected with the interface. In one exemplary implementation, the print engine and the finishing station are part of a printing machine, and the hole select system and the interface are integrated into the printing machine.

The interface allows a user to selectively locate one or more hole indicia on the media image, where the location of the hole indicia on the displayed media image indicates the hole location on the printed media. In certain embodiments, the interface includes a horizontal indicia and/or a vertical indicia displayed to indicate a horizontal and/or vertical location of the hole indicia. The interface in this embodiment allows the user to selectively locate the hole indicia by locating the horizontal and/or vertical indicia. Moreover, the user may select multiple hole indicia and simultaneously locate them while maintaining relative positioning of the plurality of hole indicia, such as by using a horizontal or vertical indicia shared by the selected group of hole indicia.

The interface may provide a touch screen with actuatable controls, or may include a user-operable cursor to allow the user to select, delete, copy and format the hole indicia. Additionally, in accordance with another aspect of the present disclosure, the location of the rendered portion of the media image is defined by at least one offset into the media image that is user modifiable via at least one offset control included on the interface. According to another aspect, the interface includes at least one ruler indicia to indicate a location within the rendered portion of the media image relative to an origin of the media image. In another aspect of the disclosure, when a user selects one of the hole indicia, a horizontal indicia, or a vertical indicia, the interface displays a tooltip on the media image. The tooltip displays one or more numerical values representing the horizontal and/or vertical location of the selected indicia.

In accordance with further aspects of the disclosure, the interface includes one or more of a display control, an opacity control, an image control and a data entry control. The display control allows the user to modify one or more characteristics of the rendered portion of the media image, for example, a grid visibility control to allow the user to selectively show and hide a grid representative of a coordinate system defining the media image, a ruler visibility control to show and hide ruler indicia, a zoom control to allow the user to change at least one dimension of the rendered portion of the media image, a distance unit control to modify display distance units, a snap on grid control to allow the user to snap the hole indicia to the grid, and a center control to allow the user to center the rendered portion within the media image. The image control allows the user to selectively show a printed image on the rendered portion of the media image, and the opacity control allows the user to change the opacity of the printed image. The data entry control allows the user enter or adjust vertical and/or horizontal values so as to selectively locate the hole indicia on the media image by setting a location with the data entry control, while also allowing the hole to be located by dragging the hole indicia.

The hole select system generates hole location data based on the user-defined hole location(s) that correspond to the location of the hole indicia on the media image, and provide the hole location data to the hole creation system.

Further aspects of the present disclosure provide a method for generating hole location data to control a hole creation system associated with a document processing system. The method includes visually rendering at least a portion of a media image representing a printed media on an interface associated with the document processing system, and allowing a user to selectively locate at least one hole indicia on the media image. Furthermore, the method includes generating the hole location data based on at least one user-defined hole location corresponding to a location of the hole indicia on the media image, and providing the hole location data to the hole creation system. In further aspects of the disclosure, the method may also include allowing the user to perform at least one of selecting, deleting, copying or formatting with respect to the hole indicia. In accordance with another aspect, the method includes allowing the user to select a plurality of hole indicia and to simultaneously locate the selected plurality of hole indicia while maintaining relative positioning of the plurality of hole indicia.

The present disclosure further provides a computer readable medium having computer executable instructions for generating hole location data. The computer readable medium includes instructions for visually rendering at least a portion of a media image representing a printed media on an interface associated with the document processing system, and for allowing a user to selectively locate at least one hole indicia on the media image. The computer readable medium further includes instructions for generating hole location data based on at least one user-defined hole location corresponding to a location of the hole indicia on the media image, and for providing the hole location data to the hole creation system. The computer readable medium may include further instructions for allowing the user to perform at least one of selecting, deleting, copying or formatting with respect to the hole indicia, and for allowing the user to select a plurality of hole indicia and to simultaneously locate the selected plurality of hole indicia while maintaining relative positioning of the plurality of hole indicia.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter.

FIG. 1 is a schematic system level diagram illustrating an exemplary document processing system with a hole select system operative to produce hole location data for a hole creation system in accordance with one or more aspects of the present disclosure;

FIG. 2 is a front elevation view of an exemplary graphical user interface having a rendered portion of a media image and various controls for manipulating the media image in the system of FIG. 1;

FIG. 3 is a front elevation view of a media image and a rendered portion of the media image region of FIG. 2;

FIG. 4 is a front elevation view of an exemplary graphical representation of the image region of FIG. 2 illustrating a user-operable cursor operative to modify formatting of a hole indicia;

FIG. 5 is a front elevation view of an exemplary graphical representation of the image region of FIG. 2 illustrating a user-operable cursor operative to modify sizing of a hole indicia;

FIG. 6 is a front elevation view of an exemplary graphical representation of the image region of FIG. 2 illustrating a user selection of a plurality of hole indicia using a shared vertical indicia;

FIG. 7 is a front elevation view of an exemplary graphical representation of the image region of FIG. 6 illustrating a user manipulation of the shared vertical indicia to move the selected group of hole indicia; and

FIG. 8 is a block diagram illustrating an exemplary method of creating hole location data in accordance with further aspects of the present disclosure.

### DETAILED DESCRIPTION

Referring now to the drawing figures, several embodiments or implementations of the present disclosure are hereinafter described in conjunction with the drawings, wherein like reference numerals are used to refer to like elements throughout, and wherein the various features, structures, and graphical renderings are not necessarily drawn to scale. The disclosure relates to document processing systems and methods in which a hole select system is operatively coupled with a graphical user interface that visually renders a media image representative of a printed media. The graphical user interface allows a user to create and visually locate one or more hole indicia on the media image, where the hole indicia indicates a location of corresponding hole(s) on the printed media and may be manipulated by the user using one or more tools of the interface. Additionally, the hole select system is operative to generate hole location data based on the hole indicia for controlling a hole creation system which produces the hole(s) on the printed media.

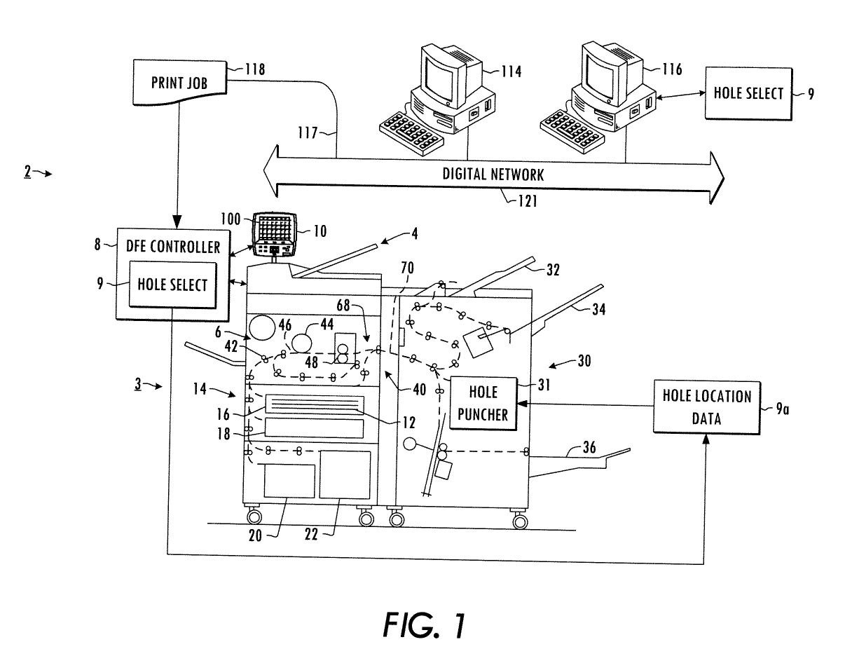

FIG. 1 illustrates an exemplary document processing or printing system 2 and a user interface 10 thereof in which one or more exemplary aspects of the disclosure may be implemented. The system 2 can be any form of commercial printing apparatus, copier, printer, facsimile machine, or other system which may include a scanner or other input device 4 that scans an original document text and/or images to create an image comprising pixel values indicative of the colors and/or brightness of areas of the scanned original, or receives images such as in a print job, and which has a marking engine or print engine 6 by which visual images, graphics, text, etc. are printed on a page or other printable medium, including xerographic, electro photographic, and other types of printing technology, wherein such components are not specifically illustrated in FIG. 1 to avoid obscuring the various aspects of the present disclosure.

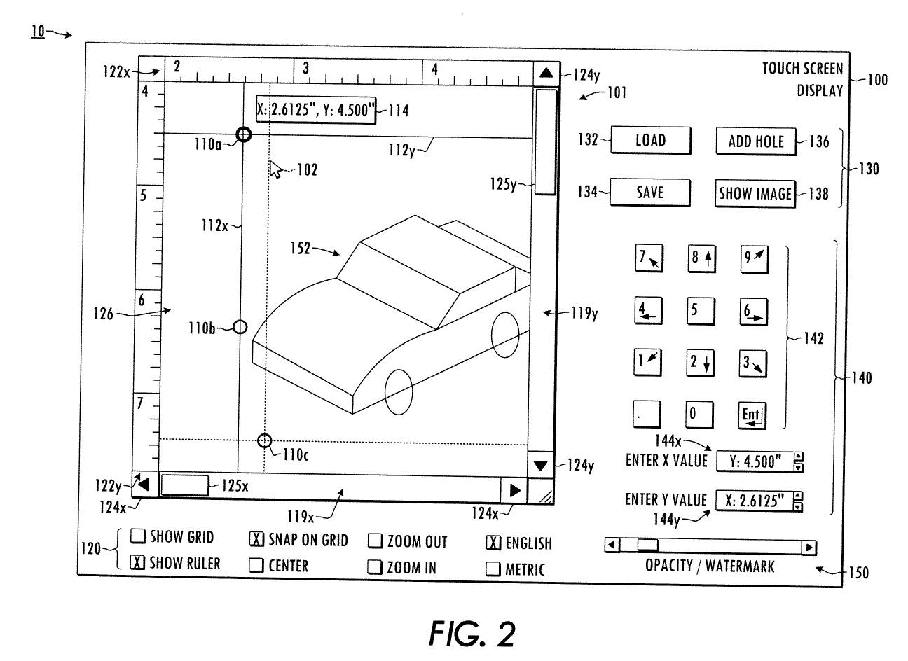

As shown in FIG. 1, the exemplary document processing system 2 includes a print engine 6, which may be any device or marking apparatus for applying an image from a digital front end (DFE) printer job controller 8 to printable media (print media) such as a physical sheet of paper, plastic, or other suitable physical media substrate for images, whether precut or web fed, where the input device 4, print engine 6, and controller 8 are interconnected by wired and/or wireless links for transfer of electronic data therebetween, including but not limited to telephone lines, computer cables, ISDN lines, etc. The printing system 2, moreover, includes an integral user interface 10 with a display 100 and suitable operator/user controls such as buttons, touch screen, etc., as illustrated and described in greater detail with respect to FIGS. 2-7 below. The print engine 6 generally includes hardware and software elements employed in the creation of desired images by electrophotographic processes wherein suitable print engines 6 may also include ink-jet printers, such as solid ink printers, thermal head printers that are used in conjunction with heat sensitive paper, and other devices capable of printing or marking an image on a printable media.

The image input device 4 may include or be operatively coupled with conversion components for converting the image-bearing documents to image signals or pixels or such function may be assumed by the printing engine 6. In the illustrated document processor 2, the printer controller 8 provides the output pixel data from memory to a print engine 6 that is fed with a print media sheets 12 from a feeding source 14 such as a paper feeder which can have one or more print media sources or paper trays 16, 18, 20, 22, each storing sheets of the same or different types of print media 12 on which the marking engine 6 can print. The exemplary print engine 6 includes an imaging component 44 and an associated fuser 48, which may be of any suitable form or type, and may include further components which are omitted from the figure so as not to obscure the various aspects of the present disclosure. In one example, the print engine 6 may include a photoconductive insulating member or photoreceptor which is charged to a uniform potential via a corotron and exposed to a light image of an original document to be reproduced via an imaging laser under control of a controller of the DFE 8, where the exposure discharges the photoconductive insulating surface of the photoreceptor in exposed or background areas and creates an electrostatic latent image on the photoreceptor corresponding to image areas of the original document. The electrostatic latent image on the photoreceptor is made visible by developing the image with an imaging material such as a developing powder comprising toner particles via a development unit, and the customer image is then transferred to the print media 12 and permanently affixed thereto in the fusing process.

In a multicolor electrophotographic process, successive latent images corresponding to different colors can be formed on the photoreceptor and developed with a respective toner of a complementary color, with each color toner image being successively transferred to the paper sheet 12 in superimposed registration with the prior toner image to create a multi-layered toner image on the printed media 12, and where the superimposed images may be fused contemporaneously, in a single fusing process. The fuser 48 receives the imaged print media from the image-forming component and fixes the toner image transferred to the surface of the print media 12, where the fuser 48 can be of any suitable type, and may include fusers which apply heat or both heat and pressure to an image. Printed media from the printing engine 6 is delivered to a finisher 30 including one or more finishing output destinations 32, 34, 36 such as trays, stackers, pans, etc., and a configurable hole creationsystem 31, in one example, a configurable hole puncher, in accordance with the present disclosure.

The document processing system 2 is operative to perform these scanning and printing tasks in the execution of print jobs, which can include printing selected text, line graphics, images, machine ink character recognition (MICR) notation, etc., on either or both of the front and back sides or pages of one or more media sheets 12. An original document or image or print job or jobs can be supplied to the printing system 2 in various ways. In one example, the built-in optical scanner 4 may be used to scan an original document such as book pages, a stack of printed pages, or so forth, to create a digital image of the scanned document that is reproduced by printing operations performed by the printing system 2 via the print engine 6. Alternatively, the print jobs can be electronically delivered to the system controller 8 via a network 121 or other means, for instance, whereby a network user can print a document from word processing software running on a network computer 114, 116 thereby generating an input print job.

A print media transporting system or network or highway 40 of the document processing system 2 links the print media source 14, the print engine 6, and the finisher 30 via a network of flexible automatically feeding and collecting drive members, such as pairs of rollers 42, spherical nips, air jets, or the like, along with various motors for the drive members, belts, guide rods, frames, etc. (not shown), which, in combination with the drive members, serve to convey the print media 12 along selected pathways at selected speeds. Print media 12 is thus delivered from the source 14 to the print engine 6 via a pathway 46 common to the input trays 16, 18, 20, 22, and is printed by the imaging component 44 and fused by the fuser 48, with a pathway 46 from the print engine 6 merging into a pathway 70 which conveys the printed media 12 to the finisher 30, where the pathways 46, 48, 70 of the network 40 may include inverters, reverters, interposers, bypass pathways, and the like as known in the art. In addition, the print engine 6 may be configured for duplex or simplex printing and a single sheet of paper 12 may be marked by two or more print engines 6 or may be marked a plurality of times by the same marking engine 6, for instance, using internal duplex pathways (not shown).

The print engine 6 and the finishing station 30 in the illustrated example are part of a printing machine 3, wherein an exemplary hole select system 9 and the interface 10 are integrated into the printing machine 3, although not a strict requirement of the present disclosure. Additionally or in combination, the hole select system 9 and the interface 10 may be integrated into at least one of the networked terminals 114, 116 as illustrated in FIG. 1, where at least one terminal 114, 116 is a general purpose computer in the illustrated example. In embodiments having a hole select system 9 integrated into a terminal 114, 116, the printing machine 3 is operatively coupled to the digital network 121 via a digital connection 117 and the terminals 114, 116 are connected to the digital network 121. In these embodiments, the digital network 121 may of any suitable form or type, including without limitation Ethernet, fiber optic, wireless, Bluetooth, or any combination thereof, and the terminals 114, 116 include a capability of sending a print job 118 and/or hole location data 9a via the digital network 121 to the printing machine 3.

The hole select system 9 is operative to produce hole location data 9a, wherein the hole location data 9a serves as a basis for the hole system 31. Any suitable hole creation system 31 may be employed by which one or more holes can be created at certain location(s) in a printed media according to the hole select data 9a, including without limitation hole punchers, drills for creating drilled holes in the media, cutting equipment such as laser cutters to cut holes in the media, etc. In the illustrated embodiment, the hole creation system 31 is a variable hole puncher capable of producing punched holes of varying size, shape, and location, where the hole creation system 31 operates in accordance with the data 9a provided by the hole select system 9. The hole select system 9 and any component thereof, whether implemented in the controller 8 or in a networked computer 114, 116 operatively associated with the printing system 2, may be any suitable hardware, software, firmware, logic, or combinations thereof that are adapted, programmed, or otherwise configured to implement the functions illustrated and described herein. For example, the controller 8, and the select system 9 in certain embodiments may be implemented, in whole or in part, as software components and may be implemented as a set of sub-components or objects including computer executable instructions of a memory, disk, or other computer readable media that can be executing on one or more hardware platforms such as one or more computers including one or more processors, data stores, memory, etc. of the system 2, or the select system 9 may be computer executable instructions executing in one of the computers 114, 116. The system 9, moreover, and components thereof, may be executed on the same computer or processor, or may be implemented in distributed fashion in two or more processing components that are operatively coupled with one another to provide the functionality and operation described herein. The exemplary document processing system 2 of FIG. 1 thus includes at least one print engine 6 operative to mark images on a printed media 12, and a finishing station 30 operative to receive printed media 12 from the print engine 6. The finishing station 30 includes a hole creation system 31 operative to selectively create holes in the printed media 12 based on hole location data 9a provided by a hole select system 9.

Referring also to FIG. 2, the document processing system 2 includes an interface 10 comprising a display 100 operative to visually render at least a portion 126 of a media image 101 representing the printed media 12. The document processing system 2 also includes a hole select system 9, whether local at the interface 10 or implemented in a networked computer 114, 116, which allows a user to selectively locate at least one hole indicia 110 on the media image 101 using the display 100. The location(s) of the hole indicia 110 on the media image 101 indicates the location(s) of one or more holes created on the printed media 12 through operation of the select system 9 generating the hole location data 9a and the hole creation system 31 operating according to the data 9a. The hole select system 9 generates the hole location data 9a based on at least one user-defined hole location corresponding to the location of the hole indicia 110 on the media image 101 and provides the location data, directly or indirectly, to the hole creation system 31.

FIG. 2 illustrates an exemplary embodiment of the interface 10 of the document processing system 2 of FIG. 1. The interface 10 includes a display 100 which may be one of a CRT monitor, an LCD monitor, and a plasma monitor, and may further include touch screen capabilities. It should be appreciated, however, that the interface may also be implemented on a networked terminal 114, 116. The interface 10 and the display 100 thereof are operable to visually display or otherwise visually render all or a portion of a media image 101 that represents the printed media 12. In the exemplary embodiment of FIG. 2, the interface 10 is shown visually rendering a user-adjustable portion 126 of the media image 101. It should be appreciated, however, that the rendered portion 126, as will be discussed infra, may display the entire media image 101, where the disclosed interface provides various display adjustment tools allowing the user to easily view any desired portion of the image 101 to facilitate easy location of hole indicia 110.

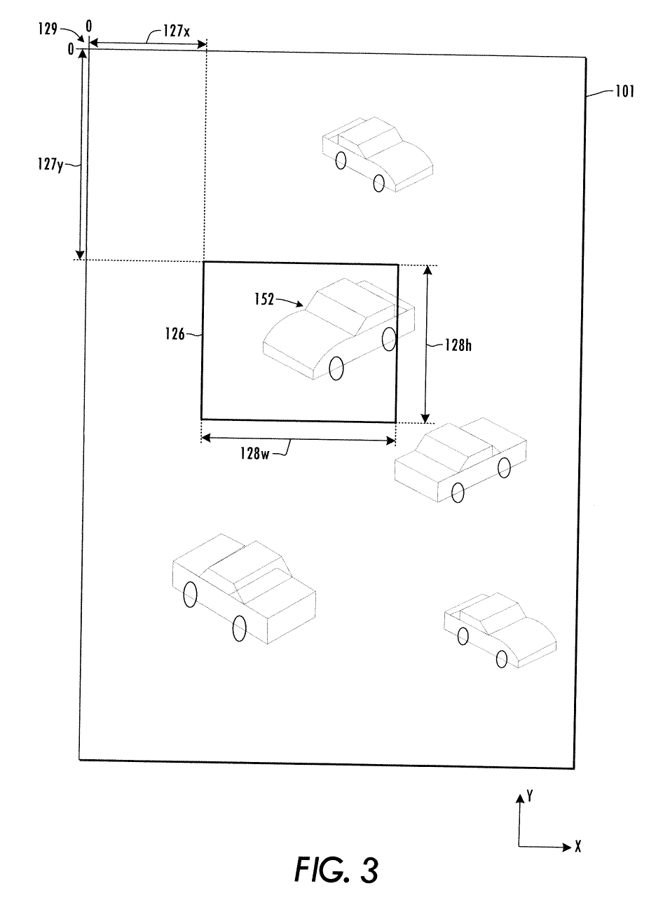

Referring also to FIG. 3, an exemplary embodiment of the media image 101 is depicted. The media image 101, as discussed supra, is a visual representation of the printed media 12 to be physically produced by the printing system 2, including marked images printed thereon and holes created therein by the hole creation system 31. In the example of FIG. 3, the printed media 12 represented by media image 101 includes a plurality of surface indicia of cars, wherein the exemplary interface 10 of the present disclosure provides user tools allowing the prospective printed image 152 to be visually rendered in the display 100 to further facilitate user placement of the hole indicia 110 relative to the printed image(s) 152. FIG. 3 further illustrates the rendered portion 126 and a corresponding offset 127 into the media image 101. While FIG. 3 is illustrative of a horizontal offset 127x and vertical offset 127y, there need not necessarily be an offset or their may only be an offset along one axis, where the concepts of the present disclosure are not limited to the illustrated examples. The offset 127 in the illustrated implementation begins at an origin 129 and extends toward the rendered portion 126. The rendered portion 126 further includes a width 128w and a height 128h, where the disclosed interface 10 provides user tools allowing the user to modify the dimensions 128 of the rendered portion 126. The dimensions may range from encompassing the whole media image 101 to only encompassing a small portion of media image 101.

As shown in FIG. 2, the interface 10 may further include one or more offset controls 124, 125. The exemplary offset controls 124, 125 allow the user to modify the location of the rendered portion 126 within the media image 101 (FIG. 3), wherein the location of the rendered portion 126 is defined by one or more offsets 127 into the media image 101. As shown in FIG. 3, the rendered portion 126 includes both a horizontal offset 127x and a vertical offset 127y into the media image 101. Offset controls 125 allow the user to modify the horizontal offset 127y and/or the vertical offset 127x by dragging a scroll block 125 along a scroll channel 119x or 119y, respectively. The length of the scroll channel in this example is representative of a dimension of the media image 101. Dragging the scroll block 125 may be accomplished by a user-operable cursor 102 (or the indicia 125 may be directly manipulated in a touch screen implementation), and the position of the scroll block 125 along its respective scroll channel 119 corresponds to the position of the rendered portion 126 in media image 101. As illustrated in FIG. 2, a vertical scroll block 125y allows the user to change the vertical offset 127y of the rendered portion 126 and a horizontal scroll block 125x allows the user to change the horizontal offset 127x of the rendered portion 126. Offset controls 124, similar to offset controls 125, allow the user to selectively increment or decrement the horizontal offset 127x and/or the vertical offset 127y of the rendered portion 126. Preferably, a user-operable cursor 102 allows the user to selectively increment or decrement the offset 127. FIG. 2 also illustrates horizontal offset indicia 124x to increment and decrement the horizontal offset 127x, and vertical offset indicia 124y to increment and decrement the vertical offset 127y. While the offset controls 124, 125 are illustrated in FIG. 2 as indicia on the interface 10, they may be implemented in any number of ways, including, but not limited to, buttons, knobs and switches, which may, but need not be part of the displayed image 101. Furthermore, the user-operable cursor and other of the illustrated and described controls may be actuated or otherwise controlled by any number of human interface devices including, but not limited to, a mouse, a touchpad, and a touch screen display.

The exemplary embodiment of FIG. 2 also includes one or more ruler indicia 112. The ruler indicia 122 indicating the location within the rendered portion 126 of the media image 101 relative to an origin 129 (FIG. 3) of the media image 101. In the embodiment of FIG. 2, both a horizontal ruler indicia 122x and a vertical ruler indicia 122y are provided. Since the rendered portion 126 is illustrated with an offset 127, the displayed portion of the ruler indicia 122 originate at the offset 127. While the ruler indicia 122 of FIG. 2 are illustrated as measuring in inches (English units), it is envisioned that any measuring scheme may be utilized, including, but not limited to metric and English units, wherein the implementation of FIG. 2 provides a user-operable control for selecting metric or English units, although not a strict requirement of the present disclosure.

In accordance with further aspects of the disclosure, FIG. 2 includes one or more display controls 120 to allow the user to modify one or more characteristics of the rendered portion 126 of the media image 101. One example is a grid visibility control that allows the user to selectively show and hide a grid (not shown) representative of a coordinate system defining the media image 101. The portion of the grid displayed, similar to the ruler indicia 122, corresponds to the rendered portion 126 of the media image 101 relative to an origin 129 of the media image 101, and will be provided in the correspondingly selected English or metric units in this example. Another exemplary display control 120 is a pair of zoom control indicia (actuated via the cursor 102 or directly by the user in touch screen embodiments) or to allow the user to change one or more dimensions 128 (FIG. 3) of the rendered portion 126 of the media image 101. As best shown in FIG. 3, the rendered portion 126 includes a width dimension 128w and a height dimension 128h. The zoom controls increase or decrease the dimensions 128 of the rendered portion 126, and the rendered portion 126 is scaled accordingly so as to fit on the interface 10 or a portion thereof. Further exemplary display controls 120 in this embodiment are the English or metric distance unit controls allowing the user to modify display distance units. As discussed above, it is envisioned that the display distance units for the ruler/grid may be based on any measuring scheme, including, but not limited to, English and metric.

The display controls 120 also include a snap on grid control operable to allow the user to snap the hole indicia 110 to the grid. When this control is active, the hole indicia 110 will snap to the nearest grid line or point once the hole indicia 110 gets within a certain proximity to a grid line. Another exemplary display control 120 is a center control to allow the user to center the rendered portion 126 within the media image 101, thereby returning the rendered portion 126 to a known location. It should be appreciated that the aforementioned display controls 120 and other controls illustrated and described in the embodiments do not encompass an exclusive listing of user modifiable characteristics of the rendered portion 126. Additionally, in the embodiment of FIG. 2, the aforementioned and other controls may be activated by a user-operable cursor 102 and/or directly by the user in touch screen implementations. As discussed above, the user-operable cursor 102 may be controlled by any human interface device, including, but not limited to a mouse, touch pad, and touch screen display. Further, any combination of the aforementioned controls is envisioned, and the controls, while displayed as indicia on the interface 10, need not necessarily be indicia on the display 100. In this regard, the controls may be one or more of one or more of a button, switch and knob, although it should be realized that the aforementioned is not an exclusive listing, and that alternate implementations may be provided in the interface separate from the display 100. Moreover, a set of the exemplary keys 142 provide arrows indicating directions, and are operable to adjust the position of the cursor 102 and/or a selected hole indicia 110 (or a selected group thereof), for example, by moving the selected indicia 110 in the direction indicated by the arrow on the actuated key 142, where the movement may be implemented in certain embodiments according to a selected grid if the ‘snap on grid’ feature is activated.

The embodiment of FIG. 2 further includes a data entry control 140 which allows the user enter or adjust vertical and/or horizontal values for hole indicia 110. The data entry control 140 may include a key control or set of keypad button indicia 142 which allows the user to selectively enter numerical values. The exemplary key control 142 includes a plurality of indicia representative of the numerical values ranging from 0 to 9. The key control 142 further includes an indicia representative of a decimal and a return or ‘enter’ key. The aforementioned indicia are user selectable via a user-operable cursor 102 (or directly by the user in touch screen implementations), where, as discussed above, the user operable cursor may be controlled by any number of human interface devices. While the key control 142 is illustrated in FIG. 2 as user selectable indicia, the key control 142 may be any external human interface device including, but not limited to, a keyboard and number pad, which may be external to the display 100.

The data entry control 140 may further include one or more value controls 144. Value controls 144 allow the user to manually enter and/or modify a numerical value with the key control 142 or selectively scroll incrementally, or decrementally, through location values. As illustrated in FIG. 2, the interface 10 includes both a horizontal value control 144x and a vertical value control 144y. It should also be appreciated that the data entry control 140 need not be implemented as indicia on interface 10 as illustrated in FIG. 2, and may in place of, or in addition to, the indicia on interface 10 be operated by an external human interface device. Moreover, as will be discussed below, in addition to the data entry control 140, the hole indicia 110 may be located by dragging, such as direct dragging by the user or by using the cursor 102.

The embodiment of FIG. 2 further provides a show image control 138 that allows the user to selectively show a printed image 152 on the rendered portion 126 of the media image 101, as well as an opacity (watermark) control 150 which allows the user to change the opacity of the depiction of the printed image 152. Accordingly, under the exemplary embodiment, a user wishing to achieve a better idea of where the holes will appear on the printed media 12 can choose to overlay a printed image 152 of the printed media 12 on the rendered portion 126, thereby being able to see the relative locations of the prospective hole(s) and image. In this embodiment, the user may increase or decrease the opacity of the overlaid image 152 via the opacity control 150, which operates like the above described offset controls 125, allowing the user to drag a control indicia along a track to adjust the opacity and/or to click (tap) or hold down end control indicia to increment or decrement the opacity value. FIG. 2 illustrates an example in which a portion of the printed image 152 is thus overlaid on the rendered portion 126 of the media image 101 such that the prospective printed image 152 (also shown on FIG. 3) is shown on the rendered portion 126. The opacity control 150 and the show image control 138 are illustrated in the figure as indicia on the interface 10 and are user selectable with a user-operable cursor 102 and/or directly via touch screen operation. As discussed above, the user-operable cursor 102 may be manipulated by a human interface device such as, but not inclusive of, a mouse, keyboard, touchpad, and touch screen display. It should also be appreciated that the controls may also be implemented by human interface devices and/or buttons, switches, or knobs.

The example of FIG. 2 also includes a control block 130 which includes the above described image control 138. The control block 130 also includes template controls 132 and 134 which allow the user save and load hole location templates. It should further be appreciated that the hole location templates may be saved as files on any number of storage devices, including, but not limited to, a hard drive, a network drive, a ram disk or a memory module of the controller 8 and/or of the host computer 114, 116. The control block 130 in this embodiment further includes an add hole control 136 which allows the user to create a new hole indicia 110 on the media image 101. In the embodiment of FIG. 2, the controls of the control block 130 manifest themselves as user selectable indicia on the interface 10, where the user may select the controls via a user-operable cursor 102 and/or via touch screen operation directly by the user. As discussed above, the user operable-cursor may, but need not be, controlled by a keyboard, mouse, touchpad, or touch screen display, etc. Furthermore, the controls need not necessarily be implemented as indicia on the interface 10, but instead, or in addition to, may be implemented as buttons, knobs, or switches, although the aforementioned list is not exclusive.

The interface 10 in the example of FIG. 2 may further selectively provide a tooltip 114 that is displayed when the user selects a hole indicia 110, a horizontal indicia 112y, or a vertical indicia 112x. When the user selects one of the aforementioned indicia, the tooltip 114 preferably displays one or more numerical values representing a horizontal location of the selected hole indicia 110, or the selected horizontal indicia 112y. Preferably, the tooltip 114 will further display one or more numerical values representing a vertical location of the selected hole indicia 110, or a currently selected vertical indicia 112x. If the user selects one of a horizontal indicia 112y and a vertical indicia 112x, the tooltip preferably displays ‘NA’ for the respective dimension that is undefined. For example, if the user selected a horizontal indicia 112y, the selected indicia would have a vertical location but no horizontal location. If the user selects a plurality of indicia, the tooltip displays ‘NA’ for the location. Additionally, as discussed above, it is envisioned that the user may change the display measurement units, and as such, the tooltip 114 varies according to the user selection of the display measurements units (e.g., English or metric in this embodiment). Moreover, the tooltip 114 is preferably displayed on the rendered portion 126, but it may also be placed elsewhere on the interface 10, and the tooltip 114 need not necessarily appear on the interface 10 and may instead be located on an external display, such as, but not limited to, a CRT monitor, LCD monitor or plasma screen.

In the exemplary embodiment of FIG. 2, the media image 101 includes one or more hole indicia 110 created and located by the user to represent holes and locations thereof to be generated by the hole creation system 31. Additionally, under a preferred embodiment the rendered portion includes one or more horizontal indicia 112y and vertical indicia 112x that extend from each hole indicia 110 that is displayed on the rendered portion 126 of media image 101. The horizontal indicia 112x indicate the horizontal location of the hole indicia 110 and the vertical indicia 112y indicate the vertical location of the hole indicia 110. In the case where the user has a plurality of hole indicia 110 sharing one of a vertical location and a horizontal location, the respective horizontal indicia 112x or vertical indicia 112y is shared by the plurality of hole indicia 110. Furthermore, as mentioned above, the vertical indicia 112y and horizontal indicia 112x are user selectable, where a tooltip 114 is displayed presenting the location of the selected indicia. Illustrated in FIG. 2, hole indicia 110a shares a horizontal indicia 112x with hole indicia 110b, and hole indicia 110c is individually associated with another pair of vertical and horizontal indicia.

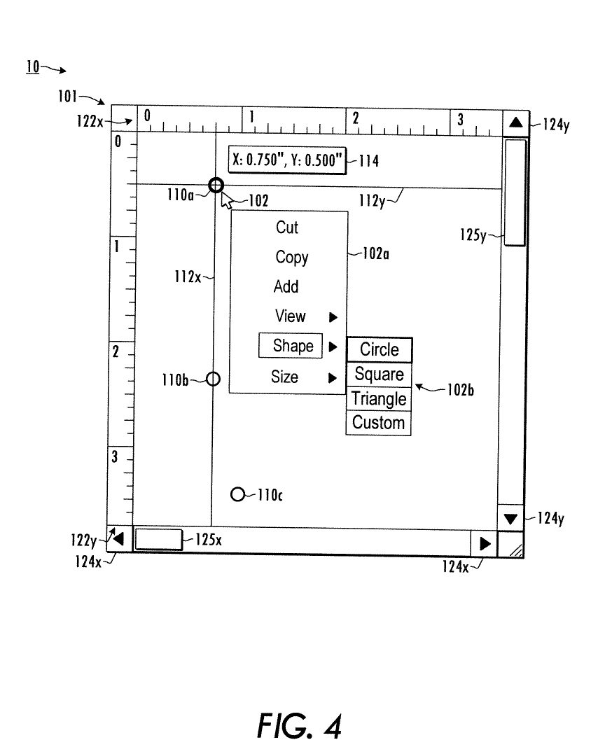

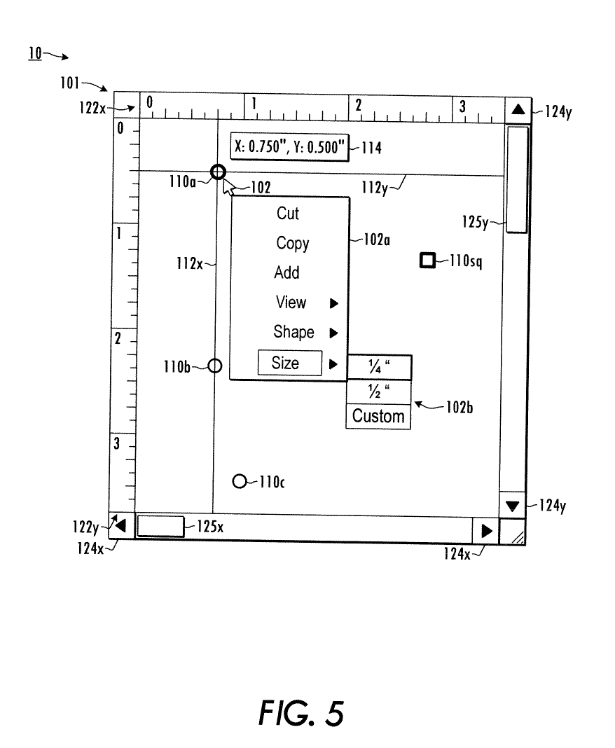

Referring also to FIGS. 4 and 5, the interface 10 may further include a user-operable cursor 102 operative to allow the user to select, delete, copy and/or format one or more hole indicia 110. These tasks and functions are exemplary only and further tasks may be implemented in other embodiments and are contemplated as falling within the scope of the present disclosure and the appended claims. Furthermore, the user-operable cursor 102 may be controllable via any number of human interface devices, including, but not limited to, a mouse, keyboard, and touch screen display. In the embodiments of FIGS. 4 and 5, the user may perform the aforementioned tasks/functions via a menu 102a which includes a user-selectable listing of available tasks, where the menu 102a may in one embodiment be controlled by selection of a given hole indicia 110 or group thereof. As discussed above, upon user selection of a hole indicia 110 (or group of indicia), a tooltip 114 is displayed showing the location of the hole indicia 110 on the media image 101. The user may further delete a hole indicia 110 from the media image 101 or copy a hole indicia 110 from a media image 101 via the task menu 102a. As illustrated in FIG. 4, the user may format one or more selected hole indicia 110, including without limitation changing the shape of the hole indicia 110, which would translate to the shape of the created hole. A nonexclusive listing of examples of shapes that may be selected are shown on submenu 102b, wherein the user may choose a circle, square, or triangle as the shape of the hole indicia, or may elect to generate a custom shape. FIG. 5 illustrates a hole indicia 110sq which has had its shape changed to a square. The hole indicia formatting may further include changing the size of the hole indicia 110 as shown on FIG. 5. In this case, the submenu 102b allows the user to change the hole size to ¼″ or ½″, or to enter a custom size, although it should be appreciated this is not exhaustive, and that other sizes are contemplated within the scope of the present disclosure. The above described tasks, may also be implemented as any combination of buttons, switches, and knobs or other user selectable indicia on the interface 10. Furthermore, the above tasks may be performed on a plurality selected hole indicia 110 simultaneously.

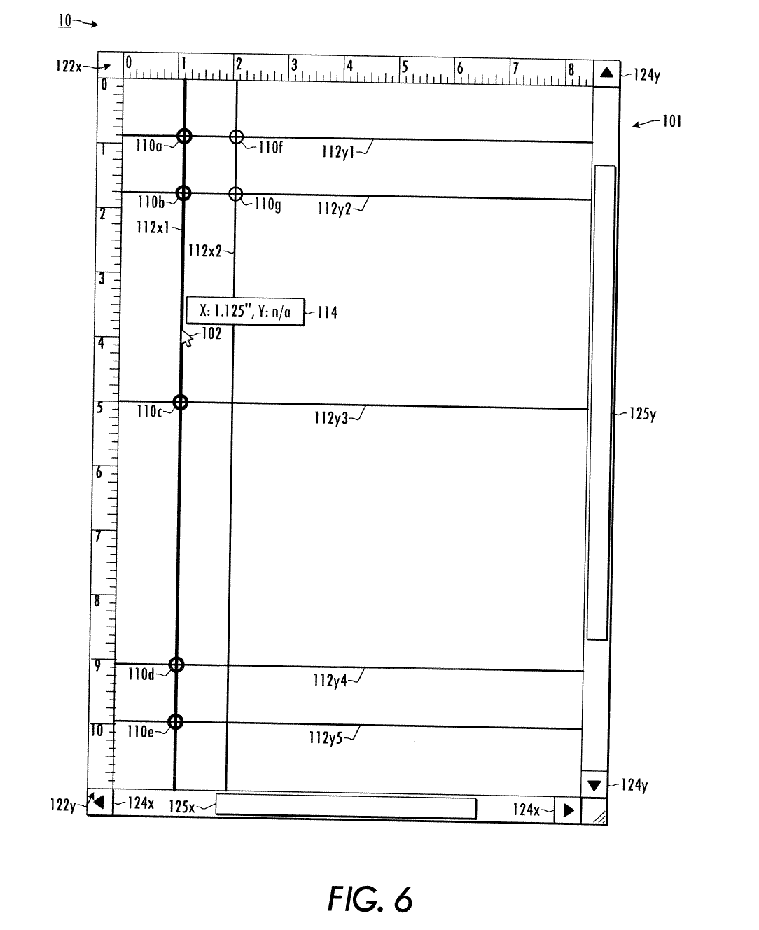

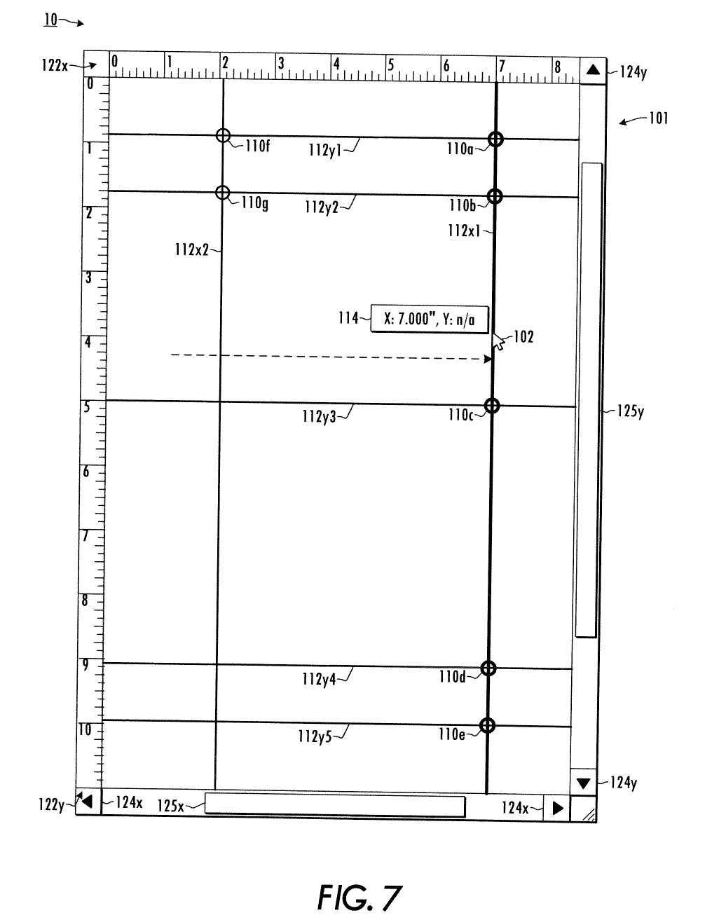

Referring now to FIGS. 6 and 7, the disclosure advantageously allows a user to easily select and jointly manipulate multiple hole indicia 110. As discussed above, moreover, each hole indicia 110 is associated with a user selectable horizontal indicia 112x and a user selectable vertical indicia 112y which represent the respective horizontal and vertical location of the corresponding hole indicia 110. Furthermore, as discussed above, hole indicia may share a horizontal or a vertical indicia 112. To Illustrate this features, FIG. 6 shows an example in which hole indicia 110a, 110b, 110c, 110d and 110e share a common horizontal indicia 112x1 (these indicia are horizontally aligned). In this example, moreover, the user has selected the shared horizontal indicia 112x1 using the cursor 102 (thereby also selecting all the horizontally aligned hole indicia 110a-110e), and, as discussed above, the tooltip 114 displays the horizontal location of the user selection (e.g., x:1.125″ in this case). Thus, when a user selects a given horizontal or a vertical indicia 112, the corresponding hole indicia 110 is/are also selected, and in the case of a shared horizontal or vertical indicia 112, the hole indicia 110 sharing the common horizontal or vertical indicia 112 are all selected. As illustrated in FIG. 6, the user has selected vertical indicia 112x1 via the user-operable cursor 102 and thus has selected hole indicia 110a, 110b, 110c, 110e and 110f sharing vertical indicia 112x1. In the illustrated embodiment, moreover, the selected vertical, horizontal, and/or hole indicia are bolded on the interface to aid the user. Although not selected in the example of FIG. 6, hole indicia 110a and 110f share a common vertical indicia 112y1, hole indicia 110b and 110g share a common vertical indicia 112y2, and hole indicia 110f and 110g share a common horizontal indicia 112x2. Furthermore, hole indicia 110c includes exclusive control over horizontal indicia 112y3, hole indicia 110d includes exclusive control over horizontal indicia 112y4, and hole indicia 110e includes exclusive control over horizontal indicia 112y5. It should also be appreciated that selection of indicia is accomplished via a user-operable cursor 102, which may be controlled by any number of human interface devices as described above. In addition, the common selection of multiple hole indicia 110 by these controls 112 allows the user to modify one or more hole properties of the selected group, such as to change the hole size, shape, etc., using the techniques and controls described above in association with FIGS. 4 and 5.

As shown in FIG. 7, the common selection of a group of hole indicia (e.g., indicia 110a-110e in this example) also allows the user to move the selected group while maintaining their relative locations to one another. Thus, in the case of FIG. 7, the user has dragged the vertical indicia 112x1 of FIG. 7 across the media image 101 (e.g., by manipulating the cursor 102, or by entering a new “X” dimension via control 144x in FIG. 2, etc.). This results in the selected group of hole indicia 110a-110e being moved as a group to a new horizontal location (e.g., x:7.00″ in this example), while each of the indicia 110a-110e retained their original vertical location values. In this implementation, moreover, by selecting a horizontal or a vertical indicia 112, the movement of the corresponding hole indicia 110 is along a single directional axis (x or y); in the case of FIG. 7, the horizontal (x) axis. Thus, when the user selects a single horizontal or vertical indicia 112, all of the corresponding selected hole indicia 110 are movable along the axis perpendicular to the selected indicia 112. In this regard, the zoom control is employed to display less than the entire media sheet, when a user selects a shared horizontal or vertical indicia, all the hole indicia 110 sharing that vertical or horizontal location are moved as a group, despite some of the selected hole indicia not being currently displayed.

Additionally, if the user selects both a horizontal and a vertical indicia simultaneously, instead of limiting the axis of movement along a single axis, the selection is instead treated as though the user has selected all the hole indicia corresponding to the selected horizontal and vertical indicia 112, by which the user can drag the group of selected hole indicia 110 in any desired direction. As illustrated in FIG. 7, the relative positioning of the hole indicia 110 corresponding to the vertical indicia 112z or horizontal indicia 112x is maintained when the user drags vertical and/or horizontal indicia 112. In this respect, the selected group of hole indicia 110a-110e in the example of FIGS. 6 and 7 retain the same position relative to each other while being dragged, and since the user has dragged the horizontal indicia 112x1 laterally across the media image 101 (in the ‘X’ direction), the horizontal indicia 112x1 and all of its corresponding horizontal indicia 110a-110e have changed their position relative to the non-selected horizontal indicia 112x2. A user may thus simultaneously select a plurality of hole indicia 110 and reposition the selected plurality of hole indicia 110 on the media image 101, while maintaining the relative positioning of the plurality of hole indicia 110. For example, the user may selected hole indicia 110f and 110g in FIG. 7 and move these two hole indicia while maintaining their relative positioning, such as by dragging the shared horizontal indicia 112x2. Accordingly, it should be appreciated that any combination of hole indicia 110, vertical indicia 112y, and/or horizontal indicia 112x may be selected simultaneously and dragged while maintaining relative positioning of the hole indicia 110 on the media image 101. As discussed above, user selection of indicia is accomplished by a user-operable cursor 102 that is controllable by any number of human interface devices, including, but not limited to, a mouse, keyboard, and touch screen display techniques.

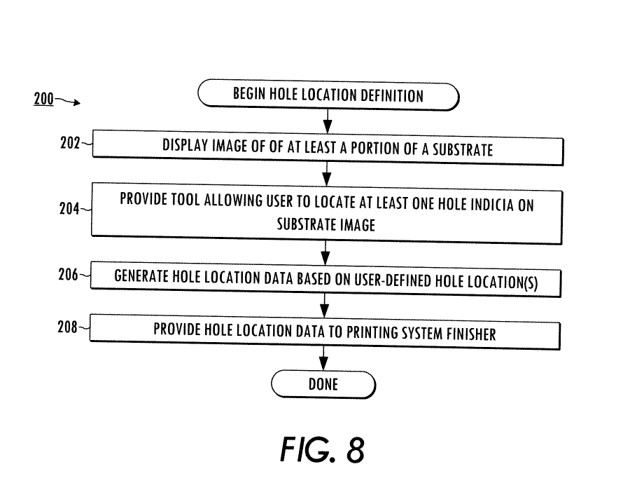

FIG. 8 provides a method 200 for generating hole location data 9a to control the hole creation system 31, above described. Although the exemplary method 200 is illustrated and described below in the form of a series of acts or events, it will be appreciated that the various methods of the disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated method 200 other methods of the disclosure may be implemented in hardware, software, or combinations thereof, such as in the exemplary hole select system 9 or the host computers 114, 116 in FIG. 1 above, and may be embodied in the form of computer executable instructions stored in a computer readable medium, such as in a memory operatively associated with the controller 8 and/or the computers 114, 116.

The method 200 begins at 202 with visually rendering all or a portion of a media image (e.g., image 101 above) representing a printed media 12 on an interface 10. As described above, the rendered portion 126 may be manipulated by the user via a plurality controls. Of note, the user may change the offset 127 of the rendered portion 126 and the dimensions 128 of the rendered portion 126. The method 200 also includes allowing a user to selectively locate at least one hole indicia 110 on the media image 101 at 204. As mentioned above, the user may select a single hole indicia 110 or a plurality of hole indicia 110 and position the hole indicia 110 on the media image 101 while maintaining the relative positioning of the hole indicia 110. The method 200 also includes generating the hole location data 9a at 206 based on at least one user-defined hole location corresponding to a location of the hole indicia 110 on the media image 101, and providing the hole location data 9a to the hole creation system 31 at 208. In further aspects of the disclosure, the method 202 may also include allowing the user to perform at least one of selecting, deleting, copying or formatting with respect to the hole indicia 110, for instance, as described above. In accordance with another aspect, the method 200 may further include allowing the user to select a plurality of hole indicia 110 and to simultaneously locate the selected plurality of hole indicia 110 while maintaining relative positioning of the plurality of hole indicia 110.

FIG. 8 is further illustrative of computer executable instructions stored in a computer readable medium for generating hole location data 9a. The computer readable medium in this regard includes instructions for visually rendering at least a portion of a media image (e.g., portion 126 of image 101 above) that represents a printed media (e.g., media 12 in the above described interface 10). Furthermore, the computer readable medium includes instructions for allowing a user to selectively locate at least one hole indicia (e.g., indicia 110) on the media image 101, for example, as described above. The computer readable medium also includes instructions for generating hole location data (data 9a in one example) based on at least one user-defined hole location corresponding to a location of the hole indicia 110 on the media image 101, and for providing 208 the hole location 9a data to the hole creation system 31. The computer readable medium may include further instructions for allowing the user to perform one or more of selecting, deleting, copying or formatting with respect to the hole indicia 110, as well as instructions for allowing the user to select a plurality of hole indicia 110 and to simultaneously locate the selected plurality of hole indicia 110 while maintaining relative positioning of the selected plurality of hole indicia 110.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

1. A document processing system, comprising:
at least one print engine operative to mark images on a printed media;
a finishing station operative to receive printed media from the print engine, the finishing station including a hole creation system operative to selectively create holes in the printed media based on hole location data;
an interface comprising a display operative to visually render at least a portion of a media image representing the printed media; and
a hole select system operatively coupled with the interface to allow a user to selectively locate at least one hole indicia on the media image, the location of the hole indicia on the media image indicating the location of a hole in the printed media, the hole select system operable to generate the hole location data based on at least one user-defined hole location corresponding to the location of the hole indicia on the media image and to provide the location data to the hole creation system.

2. The document processing system of claim 1, wherein a location of the rendered portion of the media image is defined by at least one offset into the media image, the interface further comprising at least one offset control operative to allow the user to modify the at least one offset.

3. The document processing system of claim 1, wherein the interface is further adapted to display at least one ruler indicia operative to indicate a location within the rendered portion of the media image relative to an origin of the media image.

4. The document processing system of claim 1, wherein the interface further includes at least one display control operative to allow the user to modify one or more characteristics of the rendered portion of the media image.

5. The document processing system of claim 4, wherein the media image is defined by a coordinate system, the at least one display control includes at least one of:
a grid visibility control operative to allow the user to selectively show and hide a grid representative of the coordinate system;
a ruler visibility control operative to show and hide ruler indicia;
a zoom control operative to allow the user to change at least one dimension of the rendered portion of the media image;
a distance unit control operative to modify display distance units;
a snap on grid control operative to allow the user to snap the hole indicia to the grid; and
a center control operative to allow the user to center the rendered portion within the media image.

6. The document processing system of claim 1, wherein the interface further comprises at least one image control operative to allow the user to selectively show a printed image on the rendered portion of the media image.

7. The document processing system of claim 6, wherein the interface further comprises an opacity control operative to allow the user to change an opacity of the printed image.

8. The document processing system of claim 1, wherein the interface further comprises a user-operable cursor operative to allow the user to perform at least one of selecting, deleting, copying or formatting the hole indicia.

9. The document processing system of claim 1, wherein the interface further comprises at least one of a horizontal indicia on a rendered portion of the media image and a vertical indicia on the rendered portion of the media image, the horizontal indicia indicative of a horizontal location of the hole indicia, the vertical indicia indicative of a vertical location of the hole indicia, and the interface being operative to allow the user to selectively locate the hole indicia by selectively locating one of the at least one of a horizontal indicia on the rendered portion of the media image and a vertical indicia on the rendered portion of the media image.

10. The document processing system of claim 9, wherein the interface is operative to allow the user to select a plurality of hole indicia and to simultaneously locate the selected plurality of hole indicia while maintaining relative positioning of the plurality of hole indicia.

11. The document processing system of claim 9, wherein the interface is operative to allow the user to select a plurality of hole indicia, the selected plurality of hole indicia share one of a vertical indicia and a horizontal indicia, and wherein the interface is operative to allow the user to simultaneously locate the selected plurality of hole indicia using the shared vertical or horizontal indicia.

12. The document processing system of claim 1, where upon a user selection of one of the hole indicia, a horizontal indicia and a vertical indicia, the interface is operative to display a tooltip on the media image, the tooltip displays at least one numerical value representing a horizontal location of a selected hole indicia, or a selected horizontal indicia, and at least one numerical value representing a vertical location of a selected hole indicia, or a selected vertical indicia.

13. The document processing system of claim 1, wherein the interface further comprises at least one data entry control operative to allow the user to set at least one of a vertical location value and a horizontal location value, the interface operative to allow the user to selectively locate the at least one hole indicia on the media image by way of dragging the hole indicia or setting a location with the data entry control.

14. The document processing system of claim 1, wherein the print engine and the finishing station are part of a printing machine, and the hole select system and the interface are integrated into the printing machine.

15. A method for generating hole location data operative to control a hole creation system associated with a document processing system, comprising:
visually rendering at least a portion of a media image representing a printed media on an interface operatively associated with the document processing system;
allowing a user to selectively locate at least one hole indicia on the media image;
generating the hole location data based on at least one user-defined hole location corresponding to a location of the hole indicia on the media image; and
providing the hole location data to the hole creation system.

16. The method of claim 15, further comprising allowing the user to perform at least one of selecting, deleting, copying or formatting with respect to the hole indicia.

17. The method of claim 15, further comprising allowing the user to select a plurality of hole indicia and to simultaneously locate the selected plurality of hole indicia while maintaining relative positioning of the plurality of hole indicia.

18. A computer readable medium having computer executable instructions for performing the steps of:
visually rendering at least a portion of a media image representing a printed media on an interface operatively associated with a document processing system;
allowing a user to selectively locate at least one hole indicia on the media image;
generating hole location data based on at least one user-defined hole location corresponding to a location of the hole indicia on the media image; and
providing the hole location data to a hole creation system.

19. The computer readable medium of claim 18, further comprising allowing the user to perform at least one of selecting, deleting, copying or formatting with respect to the hole indicia.

20. The computer readable medium of claim 18, further comprising allowing the user to select a plurality of hole indicia and to simultaneously locate the selected plurality of hole indicia while maintaining relative positioning of the plurality of hole indicia.
